(19) United States
(12) Patent Application Publication
(10) Pub. No.: US 2007/0189022 A1
(43) Pub. Date: Aug. 16, 2007

(54) Joint structure for angular arm for lighting fixture

(76) Inventor: Frank Tsao, Cleveland (AU)

Correspondence Address: Raymond Y. Chan, 108 N. Ynez Ave., #128, Monterey Park, CA, 91754, US

(21) Appl. No.: 11/354,283

(22) Filed: Feb. 13, 2006

(51) Int. Cl. F21V 19/00

(52) U.S. Cl. 362/382

(57) ABSTRACT

A joint structure for supporting a lighting fixture includes a tubular support arm and a tubular angular arm. The tubular supporting arm, which is adapted for supporting the lighting fixture, has a coupling end portion defining at a first free end, wherein the supporting arm includes a sliding guider inwardly protruded along the coupling end portion. The tubular angular arm has a straight engaging end portion defining at a second free end and a guiding groove, sized and shaped corresponding to the sliding guider, indently formed along the engaging end portion, such that when the engaging end portion of the angular arm is inserted into the coupling end portion of the supporting arm, the sliding guider is slidably engaged with the guiding groove to telescopingly connect the supporting arm with the angular arm so as to block an rotational movement of the supporting arm with respect to the angular arm.

### BACKGROUND OF THE PRESENT INVENTION

1. Field of Invention

The present invention relates to a lighting fixture, and more particularly to a joint structure for a lighting fixture which is capable of securely yet conveniently connecting a lighting fixture with a tubular angular arm.

2. Description of Related Arts

Lighting fixtures, such as conventional mercury vapor lamps, have been widely utilized for a wide variety of purposes. The usual practice is that the lighting fixture is supported by a supporting arrangement which comprises a tubular supporting arm having one end connected with the lighting fixture, and another end connected with a tubular angular arm which is curved or has an angular portion formed thereon. The tubular supporting arm and the tubular angular arm are then adapted to support the lighting fixture in a suspended manner.

In order to connect the tubular angular arm with the tubular supporting arm, the conventional arts is that each of the tubular supporting arm and the tubular angular arm have different internal diameters and has a through hole formed thereon, such that the relevant end of the tubular supporting arm is adapted to insert into the corresponding end of the tubular angular arm for adjusting the holes in a straight alignment. After the alignment, a fastening screw is used to penetrate the tubular angular arm and the tubular supporting arm at the straightly-aligned holes so as to lock up any lateral movement between the tubular angular arm and the tubular supporting arm with the fastening screw, so as to connect the tubular supporting arm with the tubular angular arm.

A major problem for this conventional supporting arrangement is that it is inconvenient and difficult to securely and accurately connect the tubular supporting arm with the tubular angular arm. In particular, when a user wishes to connect the tubular supporting arm with the tubular angular arm, he or she has to adjust (by rotating) the tubular angular arm for aligning the holes thereon with the holes on the tubular supporting arm. There are many potential problems for this sort of adjustment. For example, the position of the lighting fixture may be such that any rotation of the tubular angular arm is not feasible. Moreover, when the fastening screw is used to fasten the tubular supporting member and the tubular angular member, additional tools, such as screw drivers, have to be used for secure fastening of the fastening screw. The implication is that the fastening of the lighting fixtures will be as simple as it appears.

### SUMMARY OF THE PRESENT INVENTION

A main object of the present invention is to provide a joint structure for fastening a lighting fixture with a tubular angular arm in a secure, rapid and convenient manner.

Another object of the present invention is to provide a joint structure for a lighting fixture, which comprises a tubular supporting arm and a tubular angular arm slidably connecting with each other by sliding engagement of a guiding groove and a sliding guider to securely support the lighting fixture in a suspended manner. In other words, the alignment problem for conventional joint structures is avoided, in that the sliding guider and the guiding groove slide with each other for proper alignment.

Another object of the present invention is to provide a joint structure for fastening a lighting fixture, which does not involve additional fastening elements, such as fastening screws, for supporting the lighting fixture. In other words, the lighting fixture can be supported by the joint structure with minimal effort of the user of the present invention.

Another object of the present invention is to provide a joint structure for fastening a lighting fixture, which does not involve complicated mechanical structure, so as to minimize the manufacturing cost of the present invention. Moreover, the present invention requires only simple manufacturing procedures for facilitating extensive production with minimum production cost.

Another object of the present invention is to provide a joint structure for fastening a lighting fixture, which allows permanent as well as detachable connection between a tubular supporting arm and a tubular angular arm. As a result, the present invention fit for a wide range of applications.

Accordingly, in order to accomplish the above objects, the present invention provides a joint structure for supporting a lighting fixture, comprising:

a tubular supporting arm, which is adapted for supporting the lighting fixture, having a coupling end portion defining at a first free end, wherein the supporting arm comprises a sliding guider inwardly protruded along the coupling end portion; and

a tubular angular arm having a straight engaging end portion defining at a second free end and a guiding groove, sized and shaped corresponding to the sliding guider, indently formed along the engaging end portion, wherein a diameter of the engaging end portion of the angular arm is slightly smaller than a diameter of the coupling end portion of the supporting arm, such that when the engaging end portion of the angular arm is slidably inserted into the coupling end portion of the supporting arm, the sliding guider is slidably engaged with the guiding groove to telescopingly connect the supporting arm with the angular arm so as to block an rotational movement of the supporting arm with respect to the angular arm.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a joint structure for a lighting fixture according to a preferred embodiment of the present invention.

FIG. 2 is a side view of the joint structure for a lighting fixture according to the above preferred embodiment of the present invention.

FIG. 3A and FIG. 3B are an exploded perspective views of the joint structure for a lighting fixture according to the above preferred embodiment of the present invention.

FIG. 4 is a sectional side view of the joint structure for a lighting fixture according to the above preferred embodiment of the present invention.

FIG. 5 is an alternative mode of the joint structure for a lighting fixture according to the above preferred embodiment of the present invention.

### DETAILED DESCRIPTION OF THE PREFERRED EMBODIMENT

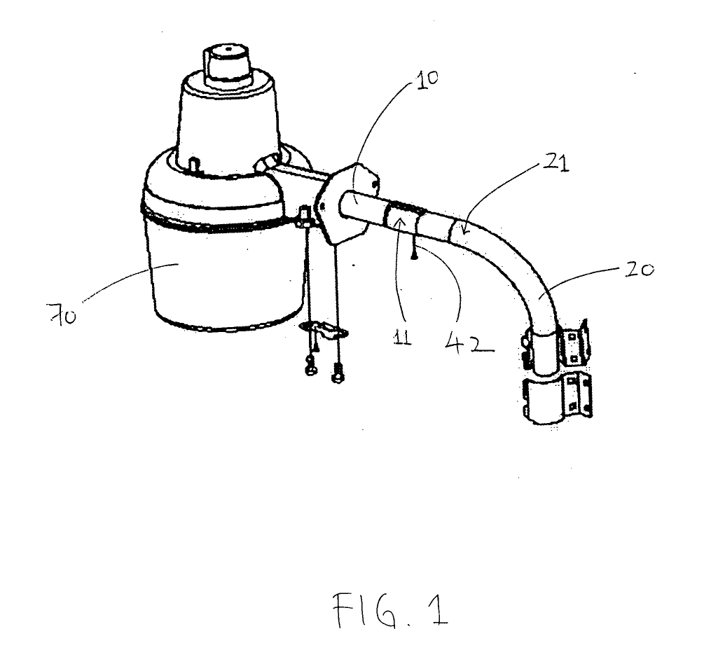

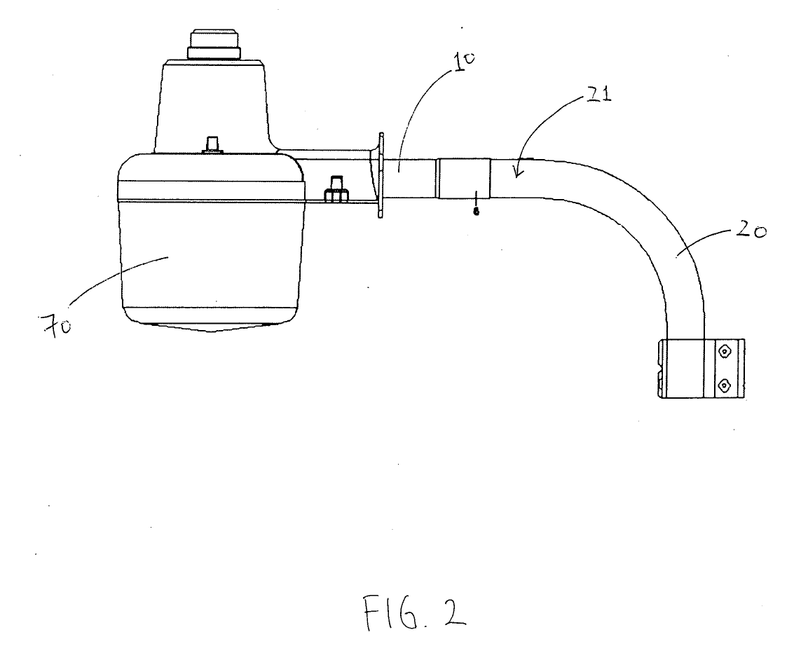

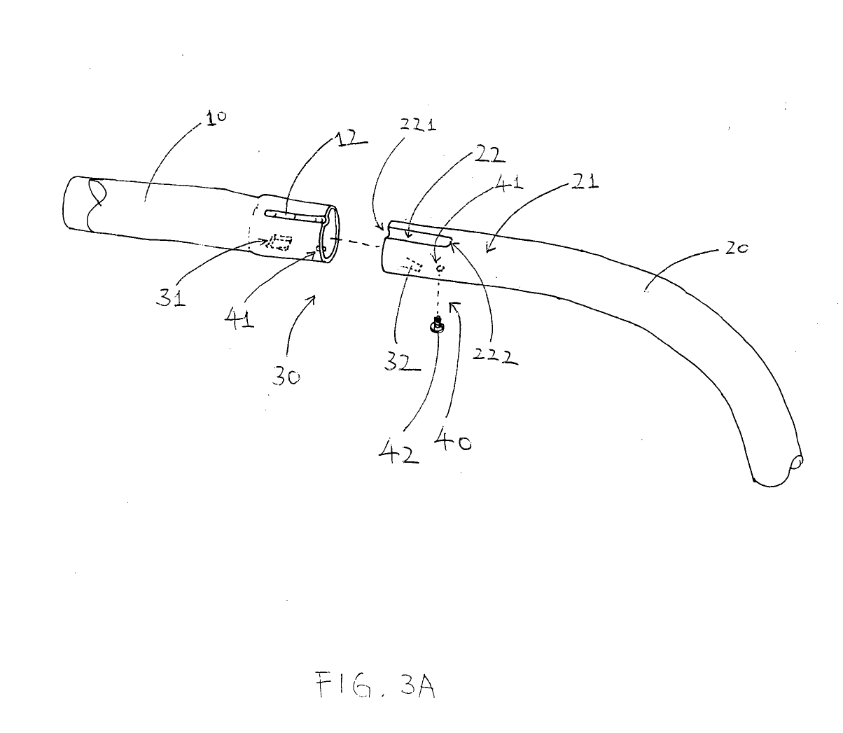

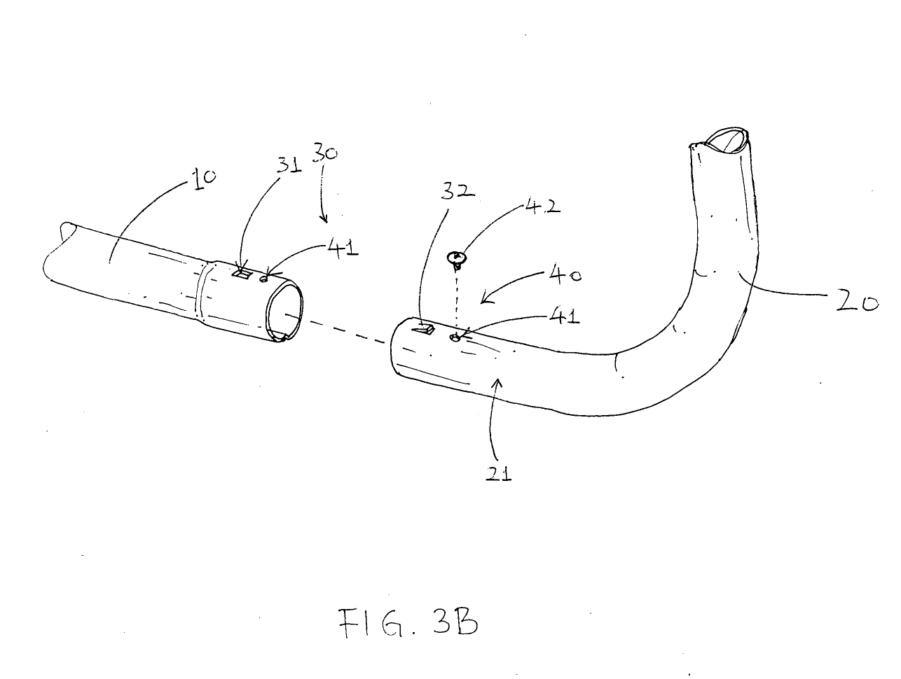

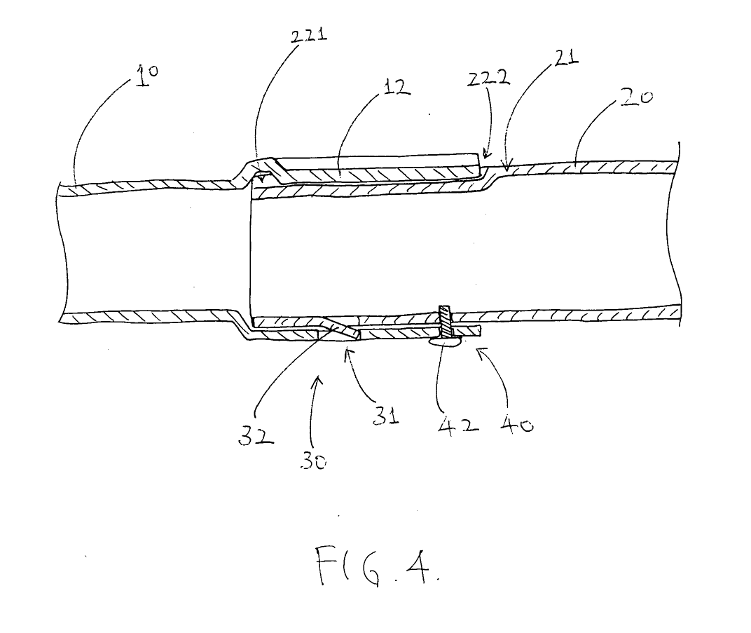

Referring to FIG. 1, FIG. 2, FIG. 3A, FIG. 3B, and FIG. 4 of the drawings, a joint structure for supporting a lighting fixture 70 according to a preferred embodiment of the present invention is illustrated, in which the joint structure comprises a tubular supporting arm 10 and a tubular angular arm 20.

The tubular supporting arm 10, which is adapted for supporting the lighting fixture 70, has a coupling end portion 11 defining at a first free end, wherein the supporting arm 10 comprises a sliding guider 12 inwardly protruded along the coupling end portion 11.

The tubular angular arm 20 has a straight engaging end portion 21 defining at a second free end and a guiding groove 22, sized and shaped corresponding to the sliding guider 12, indently formed along the engaging end portion 21, wherein a diameter of the engaging end portion 21 of the angular arm 20 is slightly smaller than a diameter of the coupling end portion 11 of the supporting arm 10, such that when the engaging end portion 21 of the angular arm 20 is slidably inserted into the coupling end portion 11 of the supporting arm 10, the sliding guider 12 is slidably engaged with the guiding groove 22 to telescopingly connect the supporting arm 10 with the angular arm 20 so as to block an rotational movement of the supporting arm 10 with respect to the angular arm 20.

According to the preferred embodiment of the present invention, the supporting arm 10 is elongated in shape and has no angular bending along its length. On the other hand, the angular arm 20 is bent to form a predetermined inclined acute angle between a first and a second arm portions.

The guiding groove 22, which is an elongated groove extended from the second free end of the angular arm 20, has an opening end 221 at the second free end and a blocking end 222 at the engaging end portion 21, such that the sliding guider 12 is slidably engaged with the guiding groove 22 from the opening end 221 thereof until a head portion of the sliding guider 12 hits the blocking end 222 of the guiding groove 22 to telescopingly connect the supporting arm 10 with the angular arm 20.

It is worth mentioning that the guiding groove 22 is indently formed on the engaging end portion 21 of the angular arm 20 wherein the sliding guider 12 slides on top of the guiding groove 22 until the head portion of the sliding guider 12 hits the blocking end 222 of the guiding groove 22. Consequently, a sideward lateral movement and rotational movement between the angular arm 20 and the supporting arm 10 are substantially restricted by two sidewalls of the guiding groove 22 so as to ensure secure connection between the angular arm 20 and the supporting arm 10.

The joint structure further comprises a locking unit 30 for securely locking up the supporting arm 10 with the angular arm 20, wherein the locking unit 30 contains a locker slot 31 formed at the coupling end portion 11 of the supporting arm 10 and comprises a locking flange 32 which is inclinedly and outwardly protruded from the engaging end portion 21 of the angular arm 20 and is arranged in such a manner that when the sliding guider 12 is slidably engaged with the guiding groove 22 to telescopingly connect the supporting arm 10 with the angular arm 20, the locking flange 32 is engaged with the locker slot 31 so as to lock up supporting arm 10 with the angular arm 20.

It is worth mentioning that the locking flange 32 has a predetermined flexibility that the locking flange 32 is adapted to be depressed to slide on an inner side of the supporting arm 10 when the engaging end portion 21 of the angular arm 20 is slidably inserted into the coupling end portion 11 of the supporting arm 10 until the locking flange 32 is aligned with the locker slot 31 to engage therewith.

In other words when the angular arm 20 is sliding with respect to the supporting arm 10, the depressed locking flange 32 is driven to slide as well along coupling end portion 11 of the supporting arm 10. When the locking flange 32 reaches the locking slot 31, the depression force exerted on the locking flange 32 is released and, due to the inherent elasticity of the locking flange 32, the locking flange 32 will move to engage with the locking slot 31 for locking up the supporting arm 10 with the angular arm 20.

Consequently, the locking flange 32 is inclinedly and outwardly extended from the engaging end portion 21 of the angular arm 20 at a direction opposite to an inserting direction of the angular arm 20 so as to prevent the angular arm 20 sliding out from the supporting arm 10 once the locking flange 32 is engaged with the locker slot 31.

It is worth mentioning that the locking slot 31 and the sliding groove 22 may be formed opposite with respect to each other so as to maximally strength the connection between the tubular supporting arm 10 and tubular angular arm 20, as shown in FIG. 4 of the drawings. Alternatively, the locking slot 31 and the siding groove 22 may be formed adjacent with each other so as to allow maximum convenience when the user tries to connect the tubular supporting arm 10 with the tubular angular arm 20.

In order to further strengthen the connection between the tubular supporting arm 10 and the tubular angular arm 20, the joint structure further of the present invention comprises a securing arrangement 40 which contains two through screws holes 41 respectively formed at the engaging end portion 21 of the angular arm 20 and the coupling end portion 11 of the supporting arm 10, wherein when the engaging end portion 21 of the angular arm 20 is slidably inserted into the coupling end portion 11 of the supporting arm 10, the two screws holes 41 are aligned with each other for allowing a securing element 42 affixing thereto so as to further secure the supporting arm 10 telescopingly connecting with the angular arm 20. It is worth mentioning that the securing element 42 has a flat head portion for minimizing a protrusion from the supporting arm 10.

As a result, the present invention has the additional advantage of further strengthening the connection between the tubular supporting arm 10 and the tubular angular arm 20 without the difficulty encountered by the above-mentioned conventional supporting arrangement for lighting fixtures, in that the alignment of the screws holes 41 are substantially guided by the engagement between the sliding guider 12 and the guiding groove 22. When the user wishes to detach the tubular angular arm 20 from the tubular supporting arm 10, he or she simply needs to slightly depress the locking flange 32 from outside so as to release the locking effect of the locking flange 32, and then pull the tubular angular arm 20 from the tubular supporting arm 10.

Finally, it is important to point out that the coupling end portion 11 of the supporting arm 10 has uniform thickness that the coupling end portion 11 of the supporting arm 10 is pressed to form the sliding guider 12 along the coupling end portion 11 so as to integrally provide the sliding guider 12 at the coupling end portion 11 for slidably engaging with the guiding groove 22 of the tubular angular arm 20. In other words, the present invention can be easily manufactured and the manufacturing cost can be minimized. Moreover, the guiding groove 22 and the sliding guider 12 can be manufactured simply by pressing so as to minimize the manufacturing cost and time of the present invention.

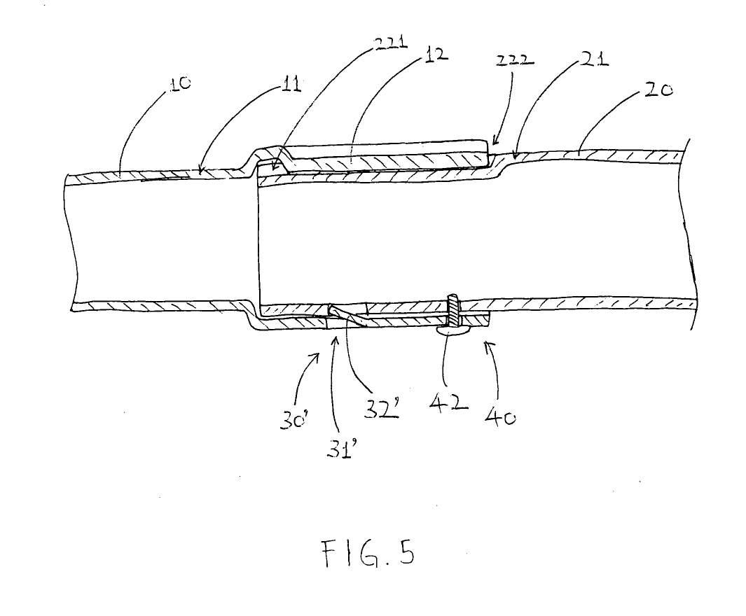

Referring to FIG. 5 of the drawings, an alternative mode of the joint structure for a lighting fixture according to the preferred embodiment of the present invention is illustrated. The alternative mode is similar to the preferred embodiment except the locking unit 30′. According to the alternative mode, the locking flange 32′ has a predetermined flexibility that the locking flange 32′ is adapted to be depressed to slide on an outer side of the angular arm 20 when the engaging end portion 21 of the angular arm 20 is slidably inserted into the coupling end portion 11 of the supporting arm 10 until the locking flange 32′ is aligned with the locker slot 31′ to engage therewith.

Thus, the locking flange 32′ is inclinedly and outwardly extended from the engaging end portion 21 of the angular arm 20 at a direction the same as an inserting direction of the angular arm 20 so as to prevent the angular arm 20 sliding out from the supporting arm 10 once the locking flange 32′ is engaged with the locker slot 31′. As a result, the tubular angular arm 20 is adapted to permanently connect with the tubular supporting arm 10 for permanent use of the joint structure.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A joint structure for supporting a lighting fixture, comprising:
a tubular supporting arm, which is adapted for supporting said lighting fixture, having a coupling end portion defining at a first free end, wherein said supporting arm comprises a sliding guider inwardly protruded along said coupling end portion; and
a tubular angular arm having a straight engaging end portion defining at a second free end and a guiding groove, sized and shaped corresponding to said sliding guider, indently formed along said engaging end portion, wherein a diameter of said engaging end portion of said angular arm is slightly smaller than a diameter of said coupling end portion of said supporting arm, such that when said engaging end portion of said angular arm is slidably inserted into said coupling end portion of said supporting arm, said sliding guider is slidably engaged with said guiding groove to telescopingly connect said supporting arm with said angular arm so as to block an rotational movement of said supporting arm with respect to said angular arm.

2. The joint structure, as recited in claim 1, wherein said guiding groove, which is an elongated groove extended from said second free end of said angular arm, has an opening end at said second free end and a blocking end at said engaging end portion, such that said sliding guider is slidably engaged with said guiding groove from said opening end thereof until a head portion of said sliding guider hits said blocking end of said guiding groove to telescopingly connect said supporting arm with said angular arm.

3. The joint structure, as recited in claim 1, further comprising a locking unit for securely locking up said supporting arm with said angular arm, wherein said locking unit contains a locker slot formed at said coupling end portion of said supporting arm and comprises a locking flange which is inclinedly and outwardly protruded from said engaging end portion of said angular arm and is arranged in such a manner that when said sliding guider is slidably engaged with said guiding groove to telescopingly connect said supporting arm with said angular arm, said locking flange is engaged with said locker slot to lock up supporting arm with said angular arm.

4. The joint structure, as recited in claim 2, further comprising a locking unit for securely locking up said supporting arm with said angular arm, wherein said locking unit contains a locker slot formed at said coupling end portion of said supporting arm and comprises a locking flange which is inclinedly and outwardly protruded from said engaging end portion of said angular arm and is arranged in such a manner that when said sliding guider is slidably engaged with said guiding groove to telescopingly connect said supporting arm with said angular arm, said locking flange is engaged with said locker slot to lock up supporting arm with said angular arm.

5. The joint structure, as recited in claim 3, wherein said locking flange has a predetermined flexibility that said locking flange is adapted to be depressed to slide on an inner side of said supporting arm when said engaging end portion of said angular arm is slidably inserted into said coupling end portion of said supporting arm until said locking flange is aligned with said locker slot to engage therewith.

6. The joint structure, as recited in claim 4, wherein said locking flange has a predetermined flexibility that said locking flange is adapted to be depressed to slide on an inner side of said supporting arm when said engaging end portion of said angular arm is slidably inserted into said coupling end portion of said supporting arm until said locking flange is aligned with said locker slot to engage therewith.

7. The joint structure, as recited in claim 4, wherein said locking flange is inclinedly and outwardly extended from said engaging end portion of said angular arm at a direction opposite to an inserting direction of said angular arm so as to prevent said angular arm sliding out from said supporting arm once said locking flange is engaged with said locker slot.

8. The joint structure, as recited in claim 6, wherein said locking flange is inclinedly and outwardly extended from said engaging end portion of said angular arm at a direction opposite to an inserting direction of said angular arm so as to prevent said angular arm sliding out from said supporting arm once said locking flange is engaged with said locker slot.

9. The joint structure, as recited in claim 1, further comprising a locking unit for securely locking up said supporting arm with said angular arm, wherein said locking unit contains a locker slot formed at said engaging end portion of said angular arm and a locking flange which is inclinedly and inwardly extended from said coupling end portion of said supporting arm and is arranged in such a manner that when said sliding guider is slidably engaged with said guiding groove to telescopingly connect said supporting arm with said angular arm, said locking flange is engaged with said locker slot to lock up supporting arm with said angular arm.

10. The joint structure, as recited in claim 2, further comprising a locking unit for securely locking up said supporting arm with said angular arm, wherein said locking unit contains a locker slot formed at said engaging end portion of said angular arm and a locking flange which is inclinedly and inwardly extended from said coupling end portion of said supporting arm and is arranged in such a manner that when said sliding guider is slidably engaged with said guiding groove to telescopingly connect said supporting arm with said angular arm, said locking flange is engaged with said locker slot to lock up supporting arm with said angular arm.

11. The joint structure, as recited in claim 9, wherein said locking flange has a predetermined flexibility that said locking flange is adapted to be depressed to slide on an outer side of said angular arm when said engaging end portion of said angular arm is slidably inserted into said coupling end portion of said supporting arm until said locking flange is aligned with said locker slot to engage therewith.

12. The joint structure, as recited in claim 10, wherein said locking flange has a predetermined flexibility that said locking flange is adapted to be depressed to slide on an outer side of said angular arm when said engaging end portion of said angular arm is slidably inserted into said coupling end portion of said supporting arm until said locking flange is aligned with said locker slot to engage therewith.

13. The joint structure, as recited in claim 10, wherein said locking flange is inclinedly and outwardly extended from said engaging end portion of said angular arm at a direction the same as an inserting direction of said angular arm so as to prevent said angular arm sliding out from said supporting arm once said locking flange is engaged with said locker slot.

14. The joint structure, as recited in claim 12, wherein said locking flange is inclinedly and outwardly extended from said engaging end portion of said angular arm at a direction the same as an inserting direction of said angular arm so as to prevent said angular arm sliding out from said supporting arm once said locking flange is engaged with said locker slot.

15. The joint structure, as recited in claim 1, further comprising a securing arrangement which contains two through screws holes respectively formed at said engaging end portion of said angular arm and said coupling end portion of said supporting arm, wherein when said engaging end portion of said angular arm is slidably inserted into said coupling end portion of said supporting arm, said two screws holes are aligned with each other for allowing a securing element affixing thereto so as to further secure said supporting arm telescopingly connecting with said angular arm.

16. The joint structure, as recited in claim 8, further comprising a securing arrangement which contains two through screws holes respectively formed at said engaging end portion of said angular arm and said coupling end portion of said supporting arm, wherein when said engaging end portion of said angular arm is slidably inserted into said coupling end portion of said supporting arm, said two screws holes are aligned with each other for allowing a securing element affixing thereto so as to further secure said supporting arm telescopingly connecting with said angular arm.

17. The joint structure, as recited in claim 14, further comprising a securing arrangement which contains two through screws holes respectively formed at said engaging end portion of said angular arm and said coupling end portion of said supporting arm, wherein when said engaging end portion of said angular arm is slidably inserted into said coupling end portion of said supporting arm, said two screws holes are aligned with each other for allowing a securing element affixing thereto so as to further secure said supporting arm telescopingly connecting with said angular arm.

18. The joint structure, as recited in claim 1, wherein said coupling end portion of said supporting arm has uniform thickness that said coupling end portion of said supporting arm is pressed to form said sliding guider along said coupling end portion so as to integrally provide said sliding guider at said coupling end portion.

19. The joint structure, as recited in claim 16, wherein said coupling end portion of said supporting arm has uniform thickness that said coupling end portion of said supporting arm is pressed to form said sliding guider along said coupling end portion so as to integrally provide said sliding guider at said coupling end portion.

20. The joint structure, as recited in claim 17, wherein said coupling end portion of said supporting arm has uniform thickness that said coupling end portion of said supporting arm is pressed to form said sliding guider along said coupling end portion so as to integrally provide said sliding guider at said coupling end portion.
